(19) United States
(12) Patent Application Publication
(10) Pub. No.: US 2010/0222997 A1
(43) Pub. Date: Sep. 2, 2010

(54) ROAD SELECTION METHOD

(75) Inventors: Lizhong Fan, Hefei (CN); Lu Zhu, Anhui (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK SINGAPORE PTE. LTD., Ayer Rajah Crescent (SG)

(21) Appl. No.: 12/424,556

(22) Filed: Apr. 16, 2009

(30) Foreign Application Priority Data
Feb. 27, 2009 (CN) 200910118096.0

(51) Int. Cl. G01C 21/36

(52) U.S. Cl. 701/200

(57) ABSTRACT

A road selection method is provided, whereby obstructed routes are avoided. First, an off road point is input on a map. Based on the off road point, an on road point is selected, having a shortest straight line distance from the off road point where no obstacle lies therebetween. Thereafter, route planning is performed based on the on road point. When defining the map, the obstacles may comprise rivers, buildings and un-traversable objects on the map.

### BACKGROUND OF THE INVENTION

1. Field of the Invention

The invention relates to route planning for navigation systems, and in particular, to a road selection method for avoidance of obstructed routes.

2. Description of the Related Art

For a typical navigation system, route planning is performed to schedule one or more optimized routes between a start point and a destination point. One or more midway points may be included on demand when planning the routes. Conventionally, the start point, destination point and midway points are input from a user interface, and point locations are required to be on the roads because the roads are the basic units for planning the routes. When a point is input off the roads, a nearest on road point is used for navigation.

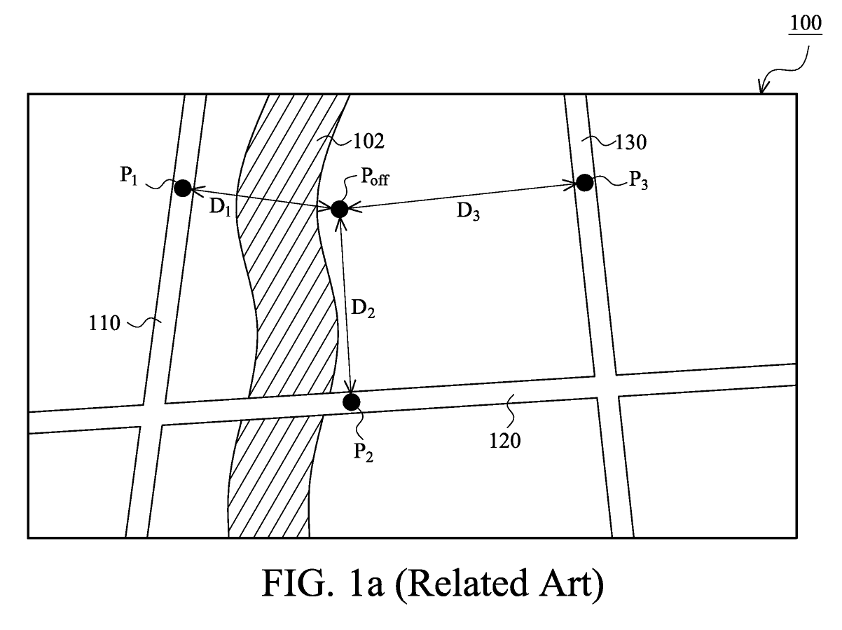

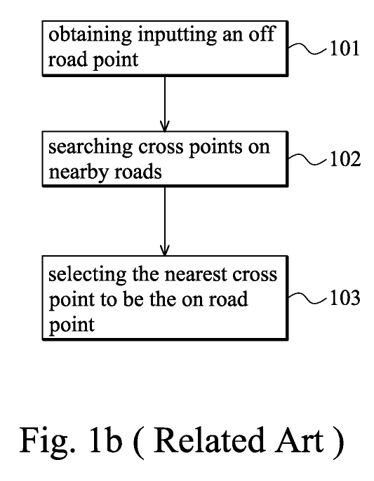

FIG. 1a shows a map 100 for a conventional road selection method. An off road point P_{off} is input at a place where no road is crossed. To find a nearest on road point for further route planning, distances from the off road point P_{off} to adjacent roads are calculated and compared. For example, there are three roads 110, 120 and 130 nearby the off road point P_{off}, and three perpendicular lines are extended from the off road point P_{off} to the roads to generate three cross points P₁, P₂ and P₃. Distances of the perpendicular lines D₁, D₂ and D₃ are compared, and the cross point corresponding to the shortest distance is selected to be the on road point. In this case, the perpendicular line D₁ is the shortest one, so the cross point P₁ is selected for further route planning. The described approach seems simple and efficient; however, the result is apparently inappropriate. As shown in FIG. 1a, there is a river 102 flowing between the cross point P₁ and the off road point P_{off}, so the cross point P₁ is actually unreachable from the off road point P_{off}, and the route planned may lead to fatal consequences.

In addition to the river 102, there may be various types of obstacles on the map 100, such as buildings, forests and mountains (not shown). Conventional navigation systems do not consider the obstacles when routing from an off road point. FIG. 1b is a flowchart of a conventional road selection method. In step 101, an off road point P_{off} is allocated by a user interface. To perform route planning, a corresponding on road point is required. In step 103, cross points P₁, P₂ and P₃ on the roads 110, 120 and 103 are respectively produced by forming perpendicular lines to the off road point P_{off}. In step 105, lengths of the perpendicular lines D₁, D₂ and D₃ are compared, and the on road point is found based on the shortest perpendicular line regardless of any obstacles. If the cross point P1 is selected to be the on road point for route planning, the planned result is deficient because it is unreachable from the off road point P_{off}. It is therefore desirable to improve the described approach.

### BRIEF SUMMARY OF THE INVENTION

An exemplary embodiment of a road selection method is provided, whereby obstructed routes are avoided. First, an off road point on a map is obtained. Based on the off road point, an on road point is selected, where no obstacle lies therebetween. Thereafter, the route planning can be performed based on the on road point. When defining the map, obstacles may comprise rivers, buildings and un-traversable objects on the map.

To select the on road point, a radius of an initial value is provided to outline a circle on the map, in which the off road point is the center of the circle. It is then determined whether the circle crosses one or more roads at one or more cross points. If no cross point is obtained, the radius is incremented and outlines another circle, and the determination of cross points is repeated.

Meanwhile, if the results of the determination of cross points continue to be unsuccessful, up to the incremented radius exceeds an upper limit, the road selection method is canceled, and invalidity of the off road point is reported. Specifically, the initial value and increment of the radius are programmable based on precision criteria, and the upper limit is programmable based on performance criteria.

Furthermore, if one or more cross points are obtained on the circle, corresponding straight lines are formed from the cross points to the off road point. It is then determined whether the straight lines are obstructed by obstacles on the map. If all straight lines are obstructed, the radius is incremented to outline another circle, and the determination of cross points is repeated. Conversely, if one of the straight lines is not obstructed, its corresponding cross point is selected to be the on road point.

As to the route planning, the selected on road point may be assigned to be a start point, a destination point or a midway point. The route is then generated based on the on road point. A detailed description is given in the following embodiments with reference to the accompanying drawings.

### BRIEF DESCRIPTION OF THE OUTLININGS

The invention can be more fully understood by reading the subsequent detailed description and examples with references made to the accompanying drawings, wherein:

FIG. 1a shows a conventional road selection method on a map 100;

FIG. 1b is a flowchart of the conventional road selection method;

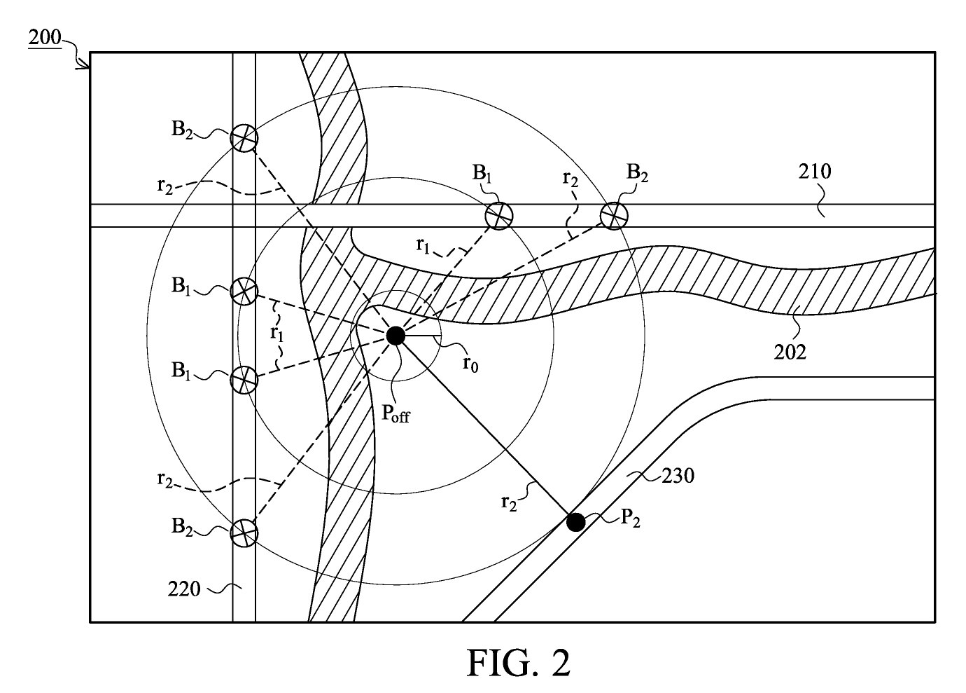

FIG. 2 shows an embodiment of road selection method on a map 200 according to the invention;

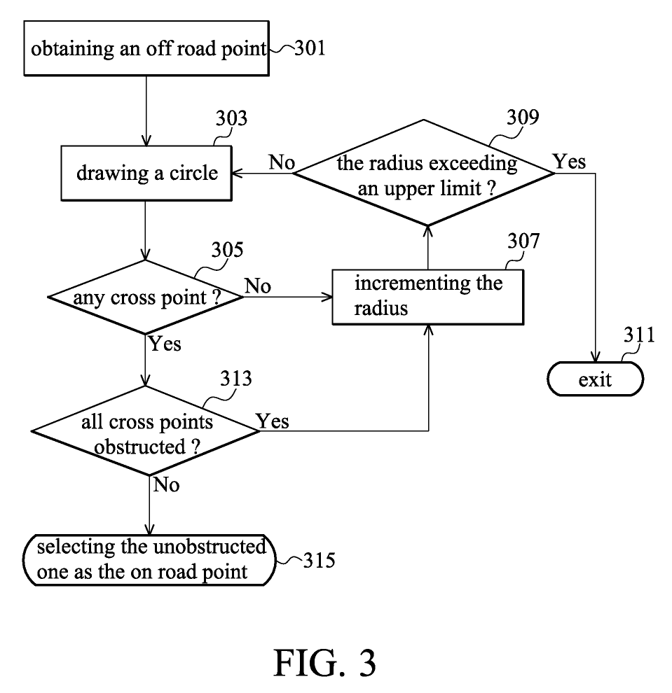

FIG. 3 is a flowchart of the road selection method according to the invention;

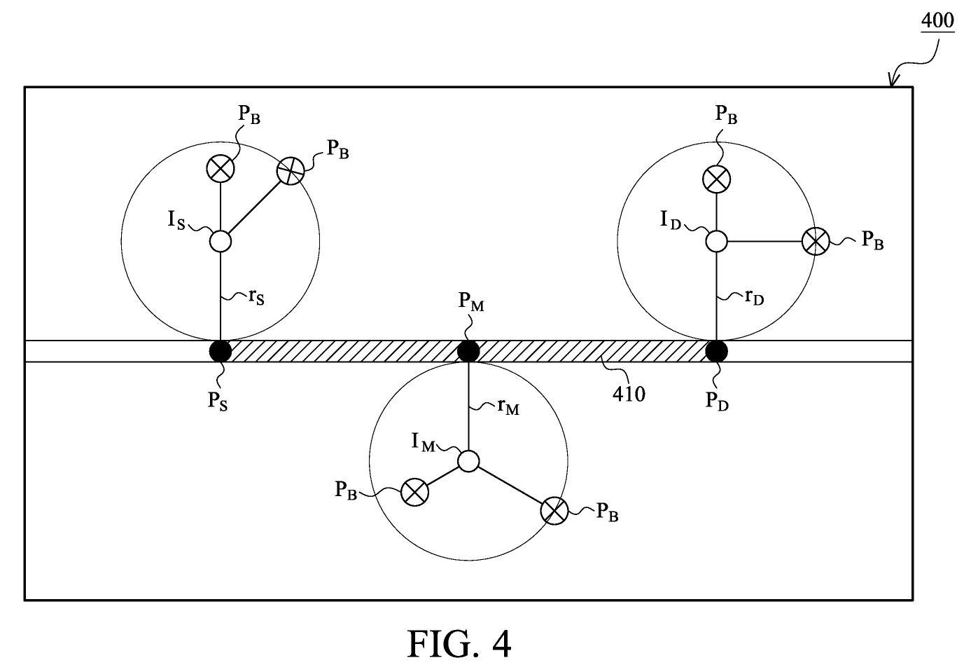

FIG. 4 shows an embodiment of route planning based on an start point, a midway point and a destination point; and

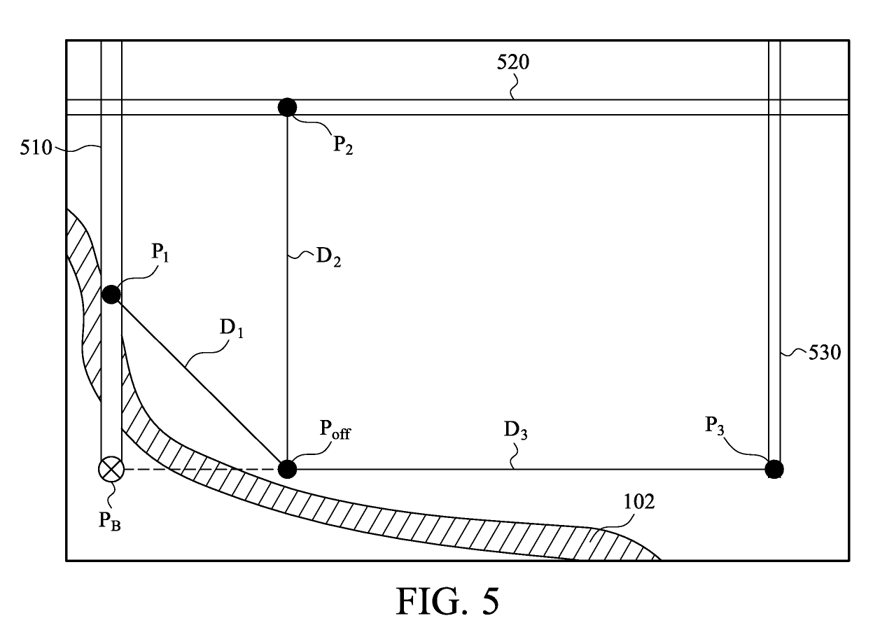

FIG. 5 shows another embodiment of road selection on a map 500.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

FIG. 2 shows an embodiment of road selection method on a map 200 according to the invention. The method is implemented in a navigation device, such as GPS, PDA or any device having navigation function. In the embodiment, distance is not the only factor to select an on road point. Preferably, obstacles are considered when selecting the roads, such that obstructed routes are avoided. As shown in FIG. 2, roads 210, 220 and 230 are presented, and an off road point P_{off} is deposited therebetween. An incrementing circle centered at the off road point P_{off} is outlined. The initial radius of the circle is r₀, and if the circle does not cross any road, the radius is incremented to outline a larger circle.

When the radius is r₁, three cross points B₁ are produced on the roads 210 and 220, and the straight lines between the cross points B₁ to the off road point P_{off} are examined for obstructions. In this case, all three cross points B₁ are obstructed by a river 202, so none of them are selected. The radius is then incremented to outline a further larger circle.

When the radius grows to r₂, a plurality of cross points is produced as candidates. As shown in FIG. 2, cross points B₂ on the roads 210 and 220 are obstructed, so they are eliminated from being a candidate. On the other hand, a cross point P₂ is found unobstructed, thus it is selected to be the on road point for further route planning. The straight line distance from the off road point P_{off} to the cross point P₂ is identical to the radius r₂. There is no requirement to enlarge the circle for further searches because distances of further points would not be shorter than the radius r₂.

FIG. 3 is a flowchart of the road selection method according to the invention. The algorithm is based on an incrementing circle with considered obstacles. In step 301, an off road point P_{off} is obtained on a location where no road is crossed. The off road point can be input by a user or selected from a database. The off road point P_{off} is used as a center for outlining circles, and the radius is provided with an initial value. In step 303, a circle of the radius centered on the off road point P_{off} is outlined. In step 305, it is determined whether the circle crosses one or more roads at one or more cross points. If no cross point is produced, step 307 is processed, in which the radius is incremented with a step value. In step 309, the incremented radius is compared with an upper limit. If the incremented radius exceeds the upper limit, the road selection method is canceled in step 311, and invalidity of the off road point P_{off} is reported. Conversely, if the incremented radius does not exceed the upper limit, step 303 is repeated, in which another circle is outlined to find cross points. The initial value and step value of the radius are programmable based on precision criteria. For example, the step value may be 5 meters or 10 meters while the initial value may be 20 meters. The upper limit is programmable based on performance criteria. For example, if the upper limit is set to 500 meters, the road selection method is deemed being failed, if no valid on road points are found within a circle of 500 meters radius.

Furthermore, if one or more cross points are found in step 305, corresponding straight lines are formed from the cross points to the off road point. In step 313, it is then determined whether the straight lines are obstructed by obstacles on the map. If all straight lines are obstructed, the process goes back to step 307 followed by steps 309, 303 and 311.

In step 315, if one of the straight lines is not obstructed, the corresponding cross point is selected to be the on road point. For example, the straight line between the cross point P₂ and the on road point Poff in FIG. 2, among the cross points produced by the circle of radius r₂, is not obstructed. Thus, the cross point P₂ is selected to be the on road point. In some cases, there may be more than one cross points found from many unobstructed straight lines at the same time. In this occasion, distances from the cross points to the destination is considered as a reference to select an on road point. Intuitively, a cross point among the cross points having the shortest distance to the destination is deemed to be the first choice. Based on the selected on road point, further route planning can be processed.

FIG. 4 shows an embodiment of route planning performed on a map 400. One start point and one destination point are essential parts for route planning, and one or more midway points may also be included in the route by demand. In FIG. 4, a route (shadowed part) is formed by one start point P_{S}, one midway point P_{M} and one destination point P_{D} on the road 410. The start point P_{S} may be found by the aforementioned algorithm when an off road point I_{S} is input. Likewise, determination of the midway point P_{M} and destination point P_{D} are based on the same algorithm. When an off road point I_{M} is deposited and assigned to be included in the route planning, the midway point P_{M} is found by the circle of radius r_{M}. Other cross points P_{B} may have shorter distances, but they are not selected because they are obstructed by obstacles. In other words, the straight line between the midway point P_{M} and the off road point I_{M} is the shortest unobstructed path for the off road point I_{M}. As to the off road point I_{D}, when it is deposited and configured to be the destination, a nearby on road point is searched using the incrementing circle. In this case, the point P_{D} is found unobstructed using the circle of radius r_{D}, thus the point P_{D} is selected to be the destination point for route planning.

FIG. 5 shows another embodiment of road selection on a map 500. Based on an off road point P_{off}, three candidate points P₁, P₂ and P₃ are obtained respectively on the roads 510, 520 and 530. Although the cross point P_{B} has the shortest distance to the off road point P_{off}, it is obstructed by a river 102 so is not used for further route planning. The distances from the off road point P_{off} to the candidate points P₁, P₂ and P₃ are D₁, D₂ and D₃, respectively. The candidate point P₁ may be selected as the start point for route planning in FIG. 4 because it has the shortest distance among the three distances D₁, D₂ and D₃. However, if the destination is closest to the road 530, it may be better to select the candidate point P₃ as the start point for route planning in FIG. 4. In other words, the selection of on road points is dependent on the distance to the destination point, whereby an optimal route can be determined.

As known, off road areas on the map may not be necessarily traversable. Obstacles can be previously defined on the map, such as rivers, buildings, lakes, parks, mountains and un-traversable objects. When an off road point is deposited, one or more on road point can be effectively searched using the aforementioned algorithm, such that route planning is facilitated with accuracy.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A road selection method applied in a navigation device, comprising:
obtaining an off road point on a map;
selecting an on road point where no obstacle lies between the off road point and the on road point; and
performing route planning based on the on road point.

2. The road selection method as claimed in claim 1, further comprising defining rivers, buildings and un-traversable objects on the map as obstacles.

3. The road selection method as claimed in claim 1, wherein the step of selecting the on road point comprises:
providing a radius of an initial value to outline a circle on the map using the off road point as the center;
determining whether the circle crosses one or more roads at one or more cross points; and
if no cross point is obtained, incrementing the radius and repeating the step of outlining a circle based on the incremented radius.

4. The road selection method as claimed in claim 3, wherein the step of selecting the on road point further comprises if the incremented radius exceeds an upper limit, the road selection method is canceled and invalidity of the off road point is reported.

5. The road selection method as claimed in claim 4, wherein the initial value and increment of the radius are programmable based on precision criteria, and the upper limit is programmable based on performance criteria.

6. The road selection method as claimed in claim 3, wherein the step of selecting the on road point further comprises:
if one or more cross points are obtained on the circle, forming one or more straight lines from the cross points to the off road point;
determining whether the straight lines are obstructed by obstacles on the map; and
if all straight lines are obstructed, incrementing the radius and repeating the step of outlining a circle.

7. The road selection method as claimed in claim 6, wherein the step of selecting the on road point further comprises if one of the straight lines is not obstructed, selecting the corresponding cross point to be the on road point.

8. The road selection method as claimed in claim 1, wherein the step of route planning comprises:
assigning the on road point to be an origin point; and
generating a route to a destination point from the on road point.

9. The road selection method as claimed in claim 1, wherein the step of route planning comprises:
assigning the on road point to be a destination point; and
generating a route from a start point to the on road point.

10. The road selection method as claimed in claim 1, wherein the step of route planning comprises:
assigning the on road point to be a midway point; and
generating a route from a start point to a destination point passing through the midway point.
